(19) United States
(12) Patent Application Publication
(10) Pub. No.: US 2006/0212421 A1
(43) Pub. Date: Sep. 21, 2006

(54) Contextual phrase analyzer

(76) Inventor: Guillermo A. Oyarce, Denton, TX (US)

Correspondence Address: WILLIAMS, MORGAN & AMERSON, 10333 RICHMOND, SUITE 1100, HOUSTON, TX, 77042, US

(21) Appl. No.: 11/374,452

(22) Filed: Mar. 13, 2006

Related U.S. Application Data
(60) Provisional application No. 60/662,954, filed on Mar. 18, 2005.

(51) Int. Cl. G06F 17/30

(52) U.S. Cl. 707/1

(57) ABSTRACT

A method and a computer system for implementing a contextual phrase analyzer engine are provided. The method includes selecting at least one of a plurality of document frequencies associated with a plurality of words used in a plurality of documents and selecting a subset of the plurality of words based on the at least one selected document frequency. The method also includes selecting at least one of the words in the subset of the plurality of words based on word frequencies associated with each word in the subset of the plurality of words.

### BACKGROUND OF THE INVENTION

1. Field of the Invention

This invention relates generally to processor-based systems, and, more particularly, to a contextual phrase analyzer.

2. Description of the Related Art

The large and growing pervasiveness of electronic documents is enriching the information environment available to users. However, the abundance of information often leads to cognitive overload as users attempt to locate relevant information within an almost infinite and constantly expanding universe of potentially related documents. Computer-based text processing may therefore be used to analyze large and complex sets of documents and to filter out extraneous information. For example, computer-based text processing may be used to retrieve relevant documents from a large document set based upon a query provided by a user. Exemplary computer-based text processing tasks include information retrieval, analysis, evaluation, synthesis, summarization, and the like.

Typical documents include words, phrases, and numerous other symbols. The words in the document both facilitate and hinder the operations performed in computer-based text processing. For example, the query provided by the user may indicate that certain words, such as “cat” are relevant and so documents that include the word “cat” may be relevant to the user. However, not all of the instances of the word “cat” are necessarily relevant to a user who is interested in documents including information about “house cats.” Thus, context identification may be a prerequisite for many text processing tasks. For example, the word “cat” may be considered ambiguous when taken out of context and may be of limited usefulness for identifying documents that are relevant to a user interested in information about “house cats.”

Disambiguation is the process of reducing the ambiguity associated with words in the document set. Disambiguation is central to many critical cognitive processes such as learning and sense making and requires the identification of a context wherein a text can exist and make sense. Disambiguation is also necessary when words or phrases are used to retrieve information and/or relevant documents in a document set. For example, identifying and/or retrieving documents that include information regarding “house cats,” and filtering out documents that include information regarding “jungle cats,” may require disambiguation of the word “cat.”

Word frequencies may also be used to identify relevant documents in a document set. For example, words that are closely associated with an upper concept of a document set (e.g., the general topic that includes contextual matter common to the document set) are typically expected to be associated with, and relevant to, the upper concept. Words that appear with a lower frequency are conversely expected to be less closely associated with, and less relevant to, the upper concept of the document set. Thus, documents that include selected words at a relatively high frequency are likely to include information associated with an upper concept that is closely related to the selected words. For example, documents that include the word “cat” at a relatively high frequency likely include information related to “cats” and these documents may be selected in response to a query from a user requesting information about “cats.”

Conventional computer-based text processing tools may have difficulty identifying relevant documents due in part to the sheer size of the information universe. For example, the word “cat” may appear with relatively high frequency in an enormous number of documents, not all of which may be of interest to a user looking for information regarding “house cats.” Furthermore, not all the words in each document, or the word combinations that form the phrases in the documents, may be relevant, even though they may appear in documents that may be considered relevant by the user. For example, the words “house” and “cat” may appear with a high frequency in documents that are not relevant to the subject of “house cats,” and some instances of the words “house” and/or “cat” may be irrelevant, even if they appear in a document that is relevant to the subject of “house cats.” Adding new documents to the document set may add new words and/or combination of words to the lexicon associated with the document set, which may lead to additional ambiguity and further complicate the task of the computer-based text processing tool.

The present invention is directed to addressing the effects of one or more of the problems set forth above.

### SUMMARY OF THE INVENTION

In embodiments of the present invention, a method and a computer system for implementing a contextual phrase analyzer engine are provided. The method includes selecting at least one of a plurality of document frequencies associated with a plurality of words used in a plurality of documents and selecting a subset of the plurality of words based on the at least one selected document frequency. The method also includes selecting at least one of words in the subset of the plurality of words based on word frequencies associated with each word in the subset of the plurality of words.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a computer system that may be used to contextually analyze information in one or more documents, in accordance with the present invention;

FIG. 2 conceptually illustrates one exemplary embodiment of a distribution of document frequencies for words in a document set, in accordance with the present invention;

FIG. 3 conceptually illustrates one exemplary embodiment of a distribution of word frequencies, in accordance with the present invention; and

FIG. 4 conceptually illustrates one exemplary embodiment of a method for selecting words from a document set, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In one embodiment, a contextual phrase analyzer engine builds a contextual tree at different levels of specificity from existing data, e.g. data extracted from one or more documents, thus synthesizing an information universe and reducing the cognitive volume to process. The contextual phrase analyzer engine takes advantage of the natural frequency distribution of words, which is known to be log-normal. It is also known that phrases also have this distribution across a large document set. Thus, weight values may be assigned to linguistic elements or terms, such as words or phrases. A probabilistic calculation such as the embodiments described below may then be used to determine the significance of the terms and the body of text. The contextual phrase analyzer engine also takes into account dynamic interactions of term frequency distributions and the interaction of the term frequency distributions with the environment.

Accordingly, while the form of the term distribution in the domain, such as a document set, may be invariant, e.g. log-normal, the rank of elements in the term distribution is not invariant across different subsets of the same domain. Log-normal distributions have been cited as part of natural phenomena and are used in computer-based text processing. However the contextual phrase analyzer engine implements the idea that ranking, or term weighting in a data set or document set, may not be constant but may instead reflect specific relationships to the environment. The contextual phrase analyzer engine thus uses dynamically changing term frequencies and/or weights to reflect the relationship that exists between the data set and specific concepts of particular interest in time and space.

In one exemplary embodiment, the contextual phrase analyzer engine may be used to analyze a document set. Persons of ordinary skill in the art should appreciate that the document set may include a single document, a plurality of documents, a plurality of portions of a document, or any combination thereof. A lookup table of linguistic terms may be constructed based upon the document set. Frequencies and/or frequency distributions associated with the linguistic terms may also be determined based upon the document set. For example, the lookup table may include words extracted from the document set, as well as the frequencies of the words and one or more documents associated with each of the words. One or more relatively important words may be determined based upon the words, frequencies, and/or associated documents extracted from the document set. For example, words in the lookup table may be ranked based, at least in part, on the frequencies and/or frequency distributions associated with these words.

The lookup table may also include linguistic terms that are combinations of the extracted words. Combinations of extracted words will be referred to hereinafter as phrases. For example, phrases including pairs of adjacent words, or other groups of associated words, may be formed using the extracted word list. Frequencies of the phrases and one or more documents associated with each of the linguistic terms may also be determined and included in the lookup table. One or more relatively important phrases may be determined based upon the words and/or phrases extracted from the document set. For example, phrases in the lookup table may be ranked based, at least in part, on the frequencies and/or frequency distributions associated with these phrases.

The linguistic terms, particularly the higher ranked and/or the relatively more important linguistic terms, may be provided to a user. The user may use the identified important words and/or phrases to identify important documents and/or portions of documents in the document set. The user may also use these terms to form and/or refine searches of the document set or some other document set.

The contextual phrase analyzer engine may offer significant advantages over conventional approaches to text processing. The main differences are in two areas: cognitive overload and computational expense. Cognitive overload may be addressed by reducing the amount of information a user must manipulate. Also the contextual phrase analyzer engine may allow the user to directly manipulate different contextual environments wherein text of interest resides for immediate evaluation. These two characteristics may provide friendly computer-user interactions. Furthermore, the number of CPU cycles may be related to the complexity of the operations to perform. The basic metric used to evaluate term significance, or term weighting, in the contextual phrase analyzer engine is a simple division, which uses relatively few CPU cycles compared to conventional systems. Conventional systems typically use complex operations requiring significantly many more CPU cycles. The cost of integrating the contextual phrase analyzer engine approach with different computer-based text processing tasks may also be reduced, at least in part because the simplicity of the process makes it flexible and/or easy to adopt.

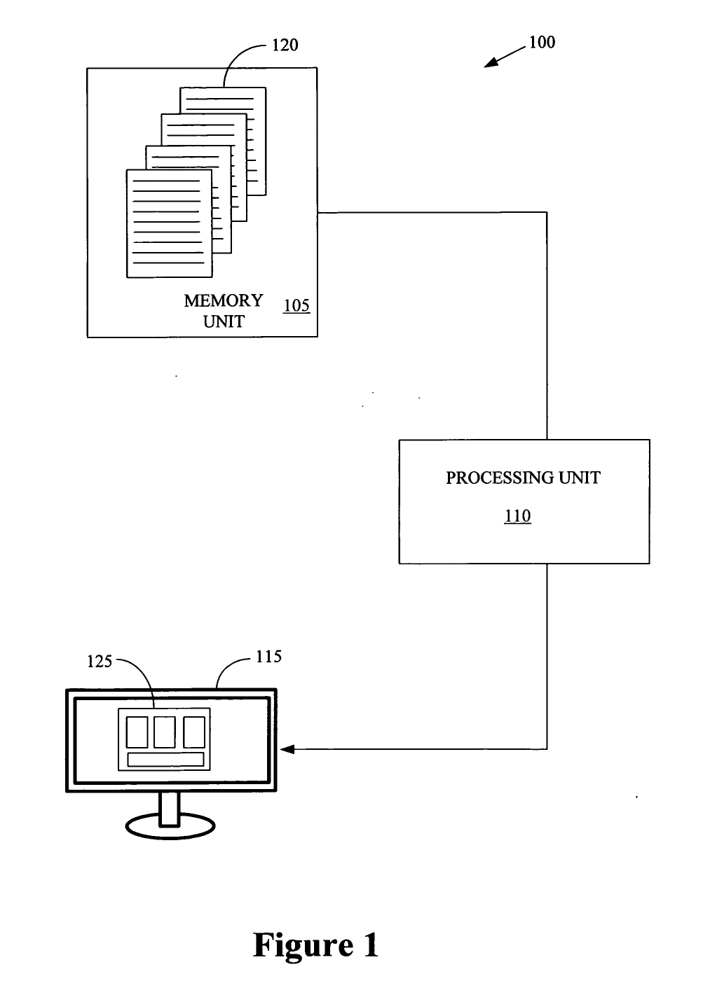

FIG. 1 conceptually illustrates one exemplary embodiment of a computer system 100 that may be used to contextually analyze information in one or more documents. In the illustrated embodiment, the computer system 100 includes a memory unit 105, a processing unit 110, and a display device 115. However, persons of ordinary skill in the art having benefit of the present disclosure should appreciate that the computer system 100 may include more or fewer components. For example, the computer system 100 may include additional memory units 105, processing units 110, and/or display devices 115, as well as other components not shown in FIG. 1. For another example, the computer system 100 may not include a display device 115. Furthermore, persons of ordinary skill in the art having benefit of the present disclosure should appreciate that the computer system 100, the memory unit 105, the processing unit 110, and/or the display device 115 may be implemented using hardware, firmware, software, or any combination thereof.

In the illustrated embodiment, the memory units 105 stores information indicative of one or more documents 120. As used herein and in accordance with common usage in the art, the term “document” is defined as the instantiation of a given upper concept of such specificity that no one single word can encompass the upper concept perfectly. Documents typically include words, numbers, and other symbols. In one embodiment, the documents 120 may be implemented as one or more files that may be stored in the memory unit 105. The documents 120 may also form a document set that includes one or more of the documents 120. As used herein and in accordance with common usage in the art, the term “document set” may be defined as the instantiation or representation of a given super upper concept that includes a combination of several individual documents that represent one or more subordinate upper concepts.

The processing unit 110 may access information indicative of the documents 120 and/or any document sets including the documents 120. In one embodiment, the processing unit 110 may read the information included in the documents 120 from the appropriate location in the memory unit 105 and may use this information to identify one or more words included in the documents 120. Alternatively, lists of the words included in each of the documents 120 may be provided to the processing unit 110. Although the following discussion will assume that words are the basic unit to be analyzed, the present invention is not limited to words. In alternative embodiments, other entities may be analyzed in the manner described below. For example, phrases including more than one word and/or other combinations of letters, numbers, and/or symbols that may be included in the documents 120 may be analyzed in the manner described below.

The processing unit 110 may then use the information indicative of the documents 120 and/or any document sets including the documents 120 to determine document frequencies associated with words included in the documents 120. As used herein and in accordance with common usage in the art, the term “document frequency” will be understood to indicate the number of documents within a document set that include a selected word. The document frequency may be expressed as a number of documents, a percentage of documents, or in any other form. For example, if the word “cat” appears in 10 documents within a document set that includes 20 documents, the document frequency associated with the word “cat” may be 10 documents or 50%.

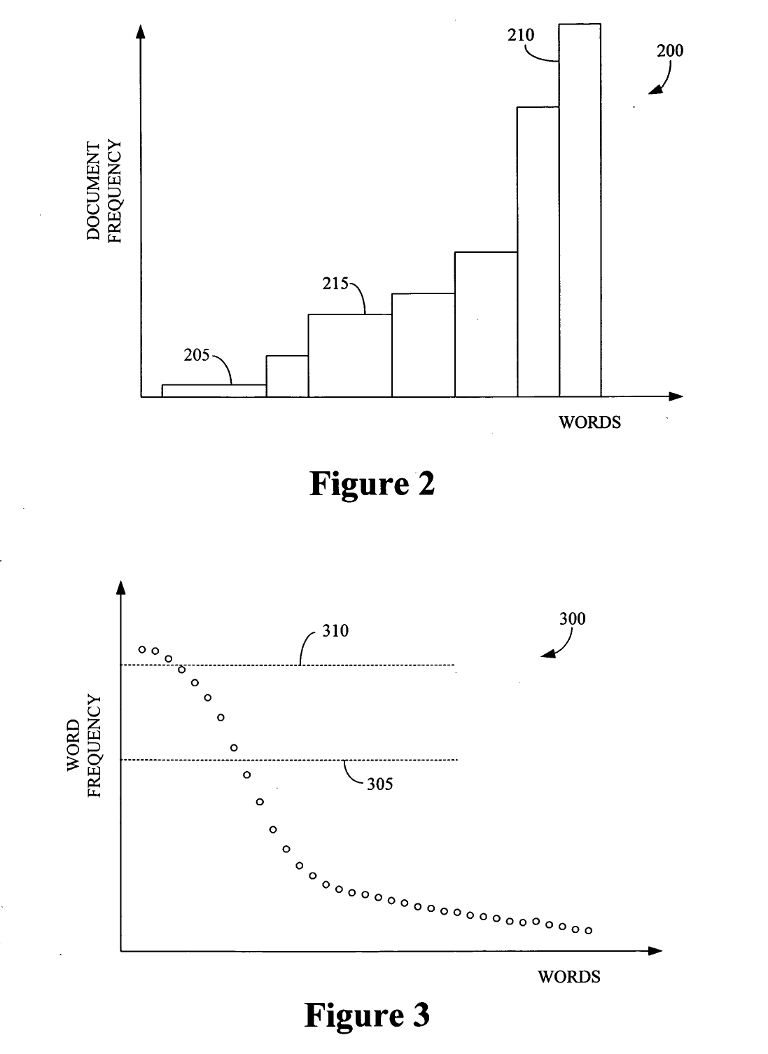

FIG. 2 conceptually illustrates one exemplary embodiment of a distribution 200 of document frequencies for words in a document set. In the illustrated embodiment, the document frequency is indicated by the vertical axis. The units of the document frequency are arbitrary and not material to the present invention. Each of the words in the documents is associated with one of the points along the horizontal axis. In the illustrated embodiment, the words have been sorted so that words with the lowest document frequencies are associated with points to the left on the horizontal axis and the words with the highest document frequencies are associated with points to the right on the horizontal axis. However, persons of ordinary skill in the art having benefit of the present disclosure should appreciate that it is not necessary to sort the words and, if the words are sorted, it is not necessary to sort them in this manner.

Words having a relatively low document frequency, e.g., words in the low document frequency tail of the document frequency distribution 200 that are in the bin 205, may not be the most useful for determining the relevance of documents in the document set. For example, the word “dog” may appear relatively rarely in documents associated with the word “cat.” Words having a relatively high document frequency may also be less useful for determining the relevance of documents in the document set. For example, words in the high document frequency tail of the document frequency distribution 200 (e.g., words in the bin 210) may be so common within the documents in the documents that that they are not particularly useful for discriminating between the documents. Words in the bin 210 may include stop words such as “the,” “a,” “it,” and the like that appear with such high frequency that they impart little or no meaning.

Referring back to FIG. 1, the processing unit 110 may select one or more of the document frequencies. In one embodiment, the processing unit 110 may reject the low and/or high frequency tails of the document frequency distribution. For example, the processing unit 110 may reject words in the bins 205, 210 shown in FIG. 2 and the words in the rejected bins 205, 210 may not be selected by the processing unit 110. The low and/or high frequency tails of the document frequency distribution may be determined in a variety of ways. For example, a percentage of the document frequencies may be assigned to the high and/or low frequency tails of the document frequency distribution. The percentage may be predetermined or may be selected by a user, e.g.; using a graphical user interface.

The processing unit 110 may select one or more bins from the center of the document frequency distribution. For example, the processing unit 110 may select the bin 215. In one embodiment, the user may provide information that may be used by the processing unit 110 to select one or more of the bins, e.g., the user may provide a number or range of bins to be selected using a graphical user interface. However, persons of ordinary skill in the art having benefit of the present disclosure should appreciate that the number of selected document frequencies is a matter of design choice and not material to the present invention.

The processing unit 110 may then select one or more words associated with the selected document frequencies. In one embodiment, the words associated with the selected document frequencies constitute a subset of the total collection of words that may be present in the documents 120. For example, the processing unit 110 may select the subset of the words that appear in the documents 120 at the document frequency indicated by the bin 215 FIG. 2. Persons of ordinary skill in the art having benefit of the present disclosure should appreciate that the number of words associated with each of the selected document frequencies depends on the particular contents and number of documents 120 and is therefore not material to the present invention.

Word frequencies associated with the selected words may then be determined by the processing unit 110. As used herein and in accordance with common usage in the art, the term “word frequency” will be understood to indicate the number of instances of a word within the documents 120. The word frequency may be expressed as a number of words, an average number of words per document 120, or in any other form. For example, if the word “cat” appears 100 times in 10 documents 120 within a document set that includes 20 documents 120, the word frequency associated with the word “cat” may be 100 instances, an average of five instances per document in the document set, or an average of 10 instances per document in the subset of documents that include the word “cat.”

FIG. 3 conceptually illustrates one exemplary embodiment of a distribution 300 of word frequencies. In the illustrated embodiment, the word frequency is indicated by the vertical axis. The units of the word frequency are arbitrary and not material to the present invention. Each of the words in the documents is associated with one of the points along the horizontal axis. In the illustrated embodiment, the words have been sorted so that words with the highest word frequencies are associated with points to the left on the horizontal axis and the words with the lowest word frequencies are associated with points to the right on the horizontal axis. However, persons of ordinary skill in the art having benefit of the present disclosure should appreciate that it is not necessary to sort the words and, if the words are sorted, it is not necessary to sort them in this manner.

The word frequency distribution 300 shown in FIG. 3 is representative of words having a selected document frequency. However, the present invention is not limited to word frequency distribution 300 associated with a single document frequency. In some alternative embodiments, the word frequency distribution 300 may be representative of words having a document frequency within a selected range of document frequencies. Relatively high word frequencies may be indicative of words that are particularly useful for determining the relevance of one or more of the documents in a document set. Accordingly, words having a word frequency above a threshold 305 may be particularly useful for determining the relevance of one or more documents. In some cases, very high word frequencies may reduce the usefulness of a word for determining relevance of one or more documents. Accordingly, in one embodiment, words having a word frequency below a threshold 310 may not be particularly useful for determining the relevance of one or more documents. In alternative embodiments, one or more of the thresholds 305, 310 (or other parameters that may be used to determine one or more of the thresholds 305, 310) may be predetermined or may be determined by a user, e.g., using a graphical user interface.

Referring back to FIG. 1, the processing unit 110 may select one or more words based upon the word frequencies associated with the words. In one embodiment, the processing unit 110 may select one or more words from the subset of words associated with a document frequency (or range of document frequencies) such that the selected words have a word frequency that is relatively high compared to word frequencies of other words having the same document frequency (or range of document frequencies). For example, the processing unit 110 may select words having a word frequency above a selected threshold word frequency, e.g., the word frequency threshold 305 shown in FIG. 3. In one embodiment, the processing unit 110 may also select one or more words such that the selected words have a word frequency that is relatively low compared to the highest word frequencies of words in the same document frequency or range thereof. For example, the processing unit 110 may select words having a word frequency below a selected threshold word frequency, e.g., the word frequency threshold 310 shown in FIG. 3.

Information indicative of the selected words may then be provided to a user. In the illustrated embodiment, the information indicative of the selected words is displayed to a user using the display device 115. For example, a graphical user interface 125 may be used to present the information indicative of the selected words to the user. In one embodiment, the user may then use the list of selected words to form one or more queries that may be used to identify and/or access relevant documents from the documents at 120. Techniques for forming and/or refining queries using selected words are described in U.S. patent application Ser. No. ______ entitled, “A Contextual Interactive Support System,” which is filed concurrently herewith and is hereby incorporated herein by reference in its entirety.

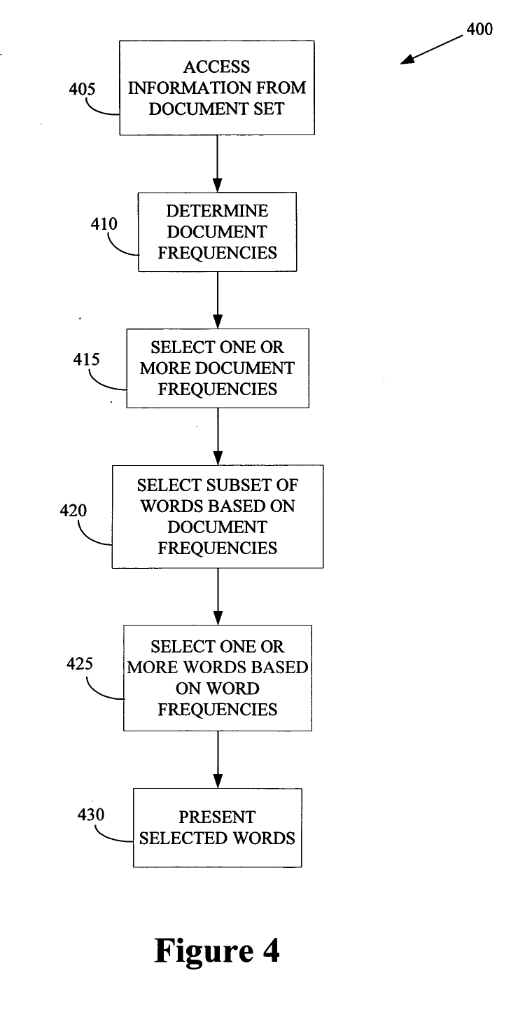

FIG. 4 conceptually illustrates one exemplary embodiment of a method 400 for selecting words from a document set. In the illustrated embodiment, information indicative of the words in a document set may be accessed (at 405) from the document set. As discussed above, accessing (at 405) the information may include reading portions of the documents directly from memory or receiving information indicative of the words in the document set. One or more document frequencies may be determined (at 410) based on the accessed information and one or more of the document frequencies may be selected (at 415). As discussed above, the document frequencies may be selected (at 415) by excluding or rejecting outlier document frequencies at the low and/or high end tail of the document frequency distribution.

A subset of the words in the document set may be selected (at 420) based on the selected document frequencies. In one embodiment, words having a selected document frequency may be selected (at 420). Alternatively, words having a document frequency within a selected document frequency range may be selected (at 420). One or more words from the selected subset may then be selected (at 425) based on the word frequencies associated with the words in the selected subset. For example, words having a relatively high word frequency compared to other words in the selected subset may be selected (at 425). The selected words may then be presented (at 430) to a user, e.g., using a graphical user interface on a display device.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
selecting at least one of a plurality of document frequencies associated with a plurality of words used in a plurality of documents;
selecting a subset of the plurality of words based on said at least one selected document frequency; and
selecting at least one of the words in the subset of the plurality of words based on word frequencies associated with each word in the subset of the plurality of words.

2. The method of claim 1, further comprising determining the plurality of document frequencies using information indicative of the plurality of words used in the plurality of documents.

3. The method of claim 2, wherein determining the plurality of document frequencies comprises accessing the information indicative of the plurality of words used in the plurality of documents.

4. The method of claim 1, wherein selecting at least one of the plurality of document frequencies comprises selecting at least one of the plurality of document frequencies based upon a distribution of document frequencies associated with the plurality of words used in the plurality of documents.

5. The method of claim 4, wherein selecting at least one of the plurality of document frequencies comprises rejecting document frequencies at a low document frequency tail of the distribution and a high document frequency tail of the distribution.

6. The method of claim 4, wherein selecting at least one of the plurality of document frequencies comprises rejecting document frequencies at the low document frequency tail of the distribution based on a first predetermined parameter and the high document frequency tail of the distribution based on a second predetermined parameter.

7. The method of claim 1, wherein selecting the subset of the plurality of words comprises selecting at least one word that appears in the plurality of documents at said at least one document frequency.

8. The method of claim 1, wherein selecting at least one of the subset of the plurality of words comprises selecting at least one of the subset of the plurality of words having relatively high word frequencies.

9. The method of claim 1, wherein selecting at least one of the subset of the plurality of words comprises selecting at least one of the subset of the plurality of words having a word frequency above a first predetermined word frequency.

10. The method of claim 9, wherein selecting at least one of the subset of the plurality of words comprises selecting at least one of the subset of the plurality of words having a word frequency below a second predetermined word frequency.

11. The method of claim 1, further comprising providing information indicative of said at least one word selected from the subset of the plurality of words to a user via a user interface.

12. A computer system, comprising:
at least one processing unit configured to:
select at least one of a plurality of document frequencies associated with a plurality of words used in a plurality of documents;
select a subset of the plurality of words based on said at least one selected document frequency; and
select at least one of the words in the subset of the plurality of words based on word frequencies associated with each word in the subset of the plurality of words.

13. The computer system of claim 12, wherein the processing unit is configured to determine the plurality of document frequencies using information indicative of the plurality of words used in the plurality of documents.

14. The computer system of claim 13, further comprising at least one memory unit, and wherein the processing unit is configured to access information indicative of the plurality of words used in the plurality of documents from the memory unit.

15. The computer system of claim 12, wherein the processing unit is configured to select at least one of the plurality of document frequencies based upon a distribution of document frequencies associated with the plurality of words used in the plurality of documents.

16. The computer system of claim 15, wherein the processing unit is configured to reject document frequencies at a low document frequency tail of the distribution and a high document frequency tail of the distribution.

17. The computer system of claim 16, wherein the processing unit is configured to reject document frequencies at the low document frequency tail of the distribution based on a first predetermined parameter and the high document frequency tail of the distribution based on a second predetermined parameter.

18. The computer system of claim 17, wherein the processing unit is configured to select at least one word that appears in the plurality of documents at said at least one document frequency.

19. The computer system of claim 12, wherein the processing unit is configured to select at least one of the subset of the plurality of words having relatively high word frequencies.

20. The computer system of claim 12, wherein the processing unit is configured to select at least one of the subset of the plurality of words having a word frequency above a first predetermined word frequency.

21. The computer system of claim 20, wherein the processing unit is configured to select at least one of the subset of the plurality of words having a word frequency below a second predetermined word frequency.

22. The computer system of claim 12, further comprising a display unit configured to display information indicative of said at least one word selected from the subset of the plurality of words to a user via a user interface.
